(19) United States
(12) Patent Application Publication
(10) Pub. No.: US 2010/0255240 A1
(43) Pub. Date: Oct. 7, 2010

(54) RELEASE SHEET AND PRESSURE-SENSITIVE ADHESIVE ARTICLE

(75) Inventors: Shiori Beppu, Saitama (JP); Naoki Taya, Saitama (JP); Toshio Sugizaki, Kanagawa (JP)

Correspondence Address: Ditthavong Mori & Steiner, P.C., 918 Prince Street, Alexandria, VA, 22314, US

(73) Assignee: LINTEC CORPORATION, TOKYO (JP)

(21) Appl. No.: 12/741,828

(22) PCT Filed: Oct. 30, 2008
(86) PCT No.: PCT/JP2008/070257

§ 371 Date: May 7, 2010

(30) Foreign Application Priority Data
Nov. 8, 2007 (JP) 2007-290921

(51) Int. Cl. C09J 7/02; B32B 27/32; B32B 33/00; C08F 110/06; C08F 110/08; C08F 110/14; C08F 210/02

(52) U.S. Cl. 428/41.8; 428/523; 526/351; 526/348.6; 526/348

(57) ABSTRACT

Providing a non-silicone release sheet that has a good release property and in which blocking does not occur even after long periods of storage in a wound roll-like shape.

A release sheet 10 is constructed by laminating an undercoat layer 12 and a release agent layer 13 on a release sheet base 11. The release agent layer 13 is formed of a polyolefin resin composition containing a polyolefin thermoplastic resin having density of 0.800 to 0.905 g/cm³ and polymerized with a multi-site catalyst. In the release agent layer 13, an average modulus of elasticity of the release agent layer at 23° C. in 50 to 1000 nm depths from the surface thereof, as measured by Nano Indentation Method, is 0.1 to 0.3 GPa, and a roughness is formed on the surface so that the surface roughness Ra₁ thereof is 100 to 700 nm.

### TECHNICAL FIELD

The present invention relates to a release sheet having a release agent layer formed of a polyolefin resin composition, and particularly relates to a release sheet used in an application on a nameplate label or a low-outgas tape for a precision electronics device such as a hard disc drive and so on.

### BACKGROUND ART

A release sheet used for a pressure-sensitive adhesive tape is constructed by laminating a release agent layer on a base sheet, and a silicone release agent is used for the release agent layer in general. In the silicone release agent, although the release property is excellent, part of a low-molecular silicone compound can be transferred to a pressure-sensitive adhesive, and thus an adherend on which the pressure-sensitive adhesive tape is adhered can be contaminated by the silicone compound. Therefore, when the pressure-sensitive sheet is used in an application for affixing in an electronics device such as a hard disc drive and so on, a malfunction in the electronics device may be induced by silicone contamination.

Accordingly, a non-silicone release agent such as a long-chain alkyl release agent, an alkyd release agent, a fluorinated release agent, a polyolefin release agent and so on is being researched for utilization instead of the silicone release agent in order to prevent a silicone contamination of the electronics device. However, applications utilizing the long-chain alkyl release agent and the alkyd release agent are limited because of their large release force; furthermore, the fluorinated release agent is expensive despite its small release force, and therefore it is difficult to utilize it for a bulk production process.

On the other hand, the polyolefin release agent is being widely used in applications that require a low release force, since the release force thereof can be made to be small (refer to Patent Citations 1 to 6). Recently, the release agent utilizing a polyolefin resin has been variously improved; for example, in Patent Citation 1, it is discussed that a roughness defined by the surface roughness Ra of 1 to 3 μm is formed on the surface of the release agent layer in order to improve the release property of the release agent layer.

Patent Citation 1: Japanese Unexamined Patent Publication (KOKAI) No. 2005-350650

Patent Citation 2: Japanese Patent Publication No. 3776120

Patent Citation 3: Japanese Unexamined Patent Publication (KOKAI) No. 2003-147295

Patent Citation 4: Japanese Unexamined Patent Publication (KOKAI) No. 2003-147294

Patent Citation 5: Published Japanese Translations of PCT International Publication for Patent Application (KOHYO): No. 11-508958

Patent Citation 6: Japanese Publication of Examined Application (KOKOKU) No. 57-45790

### DISCLOSURE OF INVENTION

### Technical Problem

By the way, generally, a release sheet is wound into a roll-like shape and then stored before bonding to a pressure-sensitive adhesive sheet. However, due to its storage in a wound and roll-like shape, the release sheet in which the polyolefin resin is used for the release agent layer has a problem in that it becomes harder to pay out a sheet from a roll, since so-called “blocking”, in which the back surface of the release sheet becomes stuck to the release agent layer, easily occurs.

Furthermore, the polyolefin resin, which is polymerized with a single-site catalyst such as a metallocene catalyst etc., is usually used for the release agent, as disclosed in Patent Citation 2. However, the physical properties of the polyolefin resin polymerized with a single-site catalyst can be dramatically changed by heating to a predetermined temperature, since the distribution ranges of the molecular weight and the composition thereof are narrow. Accordingly, even if blocking does not occur immediately after manufacturing, blocking may occur during long periods of storage at relatively high temperatures. Also, even if the release property is good immediately after manufacturing, the release property may deteriorate after a long storage period.

Therefore, the present invention was created in light of the above problems, and the object of the present invention is to provide a release sheet utilizing a polyolefin resin that has a good release property but in which blocking does not occur, even after the release sheet has been stored for a long period in a wound roll-like shape.

### Technical Solution

The release sheet of the present invention comprises a release agent layer that is formed of a polyolefin resin composition containing a polyolefin thermoplastic resin having a density of 0.800 to 0.905 g/cm³ and polymerized with a multi-site catalyst, where an average modulus of elasticity of the release agent layer at 23° C. in 50 to 1000 nm depths from the surface thereof measured by Nano Indentation Method is 0.1 to 0.3 GPa, and a roughness is formed on the surface thereof so that the surface roughness Ra₁ is 100 to 700 nm.

If the surface roughness Ra₂ is a surface roughness of the release agent layer after the release sheet has been left for 30 days in 40° C. ambient conditions, the surface roughness ratio Ra₂/Ra₁ is preferably 0.9 to 1.1. The melt flow rate of the polyolefin resin composition is preferably 1 to 20 g per 10 minutes.

For example, the above polyolefin thermoplastic resin contains at least one polyolefin resin selected from the group consisting of polyethylene, polypropylene, polybutene, poly(4-methyl-1-pentene), and a copolymer of ethylene and α-olefin with a carbon number of 3 to 10.

The release sheet may be constructed by laminating the release agent layer on a base through an undercoat layer, and preferably contains substantially no silicone compound.

A pressure-sensitive adhesive article of the present invention comprises a base, a release agent layer laminated on the base, and a pressure-sensitive adhesive layer laminated on the release agent layer and in contact with it, wherein the release agent layer is formed of a polyolefin resin composition containing a polyolefin thermoplastic resin having a density of 0.800 to 0.905 g/cm³ and polymerized with a multi-site catalyst, an average modulus of elasticity of the release agent layer at 23° C. in 50 to 1000 nm depths from a surface thereof measured by Nano Indentation Method is 0.1 to 0.3 GPa, and a roughness is formed on the surface thereof so that the surface roughness Ra₁ is 100 to 700 nm.

For example, the pressure-sensitive adhesive layer is preferably formed of an acrylic pressure-sensitive adhesive, and the pressure-sensitive adhesive article preferably contains substantially no silicone compound either.

### ADVANTAGEOUS EFFECTS

In a release sheet utilizing a polyolefin resin, while the good release property can be maintained, the occurrence of blocking can be prevented even in long-term storage.

### BRIEF DESCRIPTION OF DRAWINGS

FIG. 1 is a schematic sectional view showing a release sheet in the present embodiment.

FIG. 2 is a schematic sectional view showing a pressure-sensitive adhesive article in the present embodiment.

### BEST MODE FOR CARRYING OUT THE INVENTION

Embodiments of the present invention will be explained below, in reference to the drawings.

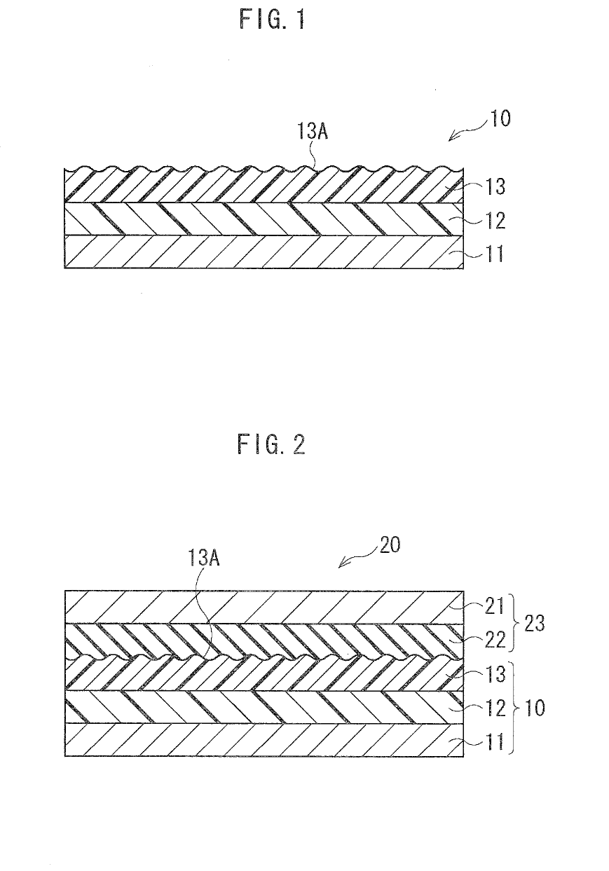

FIG. 1 is a schematic sectional view showing a release sheet in an embodiment of the present invention. FIG. 2 is a schematic sectional view showing a pressure-sensitive adhesive article in the embodiment. As shown in FIG. 1, a release sheet 10 is constructed by laminating an undercoat layer 12 and a release agent layer 13 in sequence, on one surface of a release sheet base 11. The release agent layer 13 is formed of a polyolefin resin composition, and numerous concavities and convexities (roughness) are formed on a surface 13A thereof.

As shown in FIG. 2, a pressure-sensitive adhesive article 20 is constructed by bonding a pressure-sensitive adhesive sheet 23, which is formed by laminating a pressure-sensitive adhesive layer 22 on a surface of a pressure-sensitive adhesive sheet base 21, to the release sheet 10, such that the pressure-sensitive adhesive layer 22 makes contact with the surface 13A of the release agent layer 13. The release sheet 10 may be wound alone into a roll-like shape and then stored, or it may be wound into a roll-like shape after it is made into the pressure-sensitive adhesive article 20 by bonding it to the pressure-sensitive adhesive sheet 23 and then stored.

The polyolefin resin composition for forming the release agent layer 13 contains at minimum a polyolefin thermoplastic resin with density of 0.800 to 0.905 g/cm³ that is polymerized with a multi-site catalyst. Here, the density is measured in accordance with JIS K7112-1999. The density of the above polyolefin thermoplastic resin is preferably 0.850 to 0.905 g/cm³, and is most preferably 0.880 to 0.905 g/cm³.

An example of the above multi-site catalyst includes a Ziegler catalyst, a Phillips catalyst, and a Standard catalyst. The Ziegler catalyst comprises a main catalyst composed of a transition metal compound such as a titanium compound, a vanadium compound, and others; a co-catalyst composed of an organic metal compound such as an organic aluminum and others; and a catalyst support composed of an oxide of silicon, titanium, magnesium, or others. The Phillips catalyst comprises a main catalyst composed of chromium oxide, and a catalyst support composed of an oxide of aluminum or others. The Standard catalyst comprises a main catalyst composed of molybdenum oxide, and a catalyst support composed of an oxide of aluminum or others.

The ratio (Mw/Mn) of weight-average molecular weight (Mw) to number-average molecular weight (Mn) by Gel Permeation Chromatography (GPC) of the above polyolefin thermoplastic resin is preferably greater than or equal to 3, Mw/Mn is more preferably 3 to 10, and Mw/Mn is most preferably 3.6 to 8.

For example, polyethylene, polypropylene, polybutene, poly(4-methyl-1-pentene), a copolymer of ethylene and α-olefin with the carbon number of 3 to 10, or a mixture of two or more kinds selected from these is used as the above polyolefin thermoplastic resin. Among these, the copolymer of ethylene and α-olefin with the carbon number of 3 to 10 is especially preferable. Further, the release property of the release sheet is improved by determining the density of the above thermoplastic resin within the range described above. Furthermore, if the above thermoplastic resin is polymerized with the multi-site catalyst, it is easy to determine the Mw/Mn within the above-mentioned range; hence the predetermined release property is maintained and blocking hardly occurs even after long-term storage in a state where the release sheet 10 is wound into a roll-like shape, since the roughness formed on the surface of the release agent layer is hardly changed.

The resin component in the above polyolefin resin composition may only contain the polyolefin thermoplastic resin having the density of 0.800 to 0.905 g/cm³, but may also contain one having a density outside this range in perspective of the layer formability; for example, it may further contain a polyolefin thermoplastic resin such as a polyethylene resin such as low density polyethylene (LDPE, density: greater than or equal to 0.910 g/cm³ and less than 0.930 g/cm³), medium density polyethylene (MDPE, density: greater than or equal to 0.930 g/cm³ and less than 0.942 g/cm³), high density polyethylene (HDPE, density: greater than or equal to 0.942 g/cm³), and others; polypropylene resin (PP); olefin elastomers (TPO); and others. Among these, the polyethylene resin is preferable and the low density polyethylene is especially preferable. The ratio (Mw/Mn) of weight-average molecular weight (Mw) to number-average molecular weight (Mn) by Gel Permeation Chromatography (GPC) of this polyethylene resin is preferably greater than or equal to 6, since the layer formability can be improved.

The ratio of the polyolefin thermoplastic resin having the density of 0.800 to 0.905 g/cm³ and polymerized with a multi-site catalyst contained in the above polyolefin resin composition is preferably 50 to 100 weight %, and is most preferably 60 to 100 weight %, with respect to 100 weight % of the polyolefin resin composition. Of course, the polyolefin resin composition may contain a polyolefin resin other than the above-mentioned polyolefin thermoplastic resin or other resin.

The melt flow rate (MFR) of the polyolefin resin composition is preferably 1 to 20 g per 10 minutes. If the MFR is below 1 g per 10 minutes, forming the layer becomes difficult because of the low flow property; if it is over 20 g per 10 minutes, it is difficult to form the layer having uniform thickness because of the excessively high flow property. The MFR is measured in accordance with JISK7210-1997 under the measuring conditions of temperature at 190° C. and load of 21.2N. Furthermore, the thickness of the release agent layer 13 is preferably 3 to 30 μm.

In the present embodiment, the average modulus of elasticity at 23° C. in 50 to 1000 nm depths from the surface 13A of the release agent layer 13 is determined to be 0.1 to 0.3 GPa, by using the above-mentioned resins either suitably mixed or singularly. The average modulus of elasticity at 23° C. is measured by Nano Indentation Method [Measuring Instrument: Nano Indenter (brand name: Nano Indenter SA2; manufactured by MTS System Corp.)], and is calculated as an arithmetic average of the values of modulus of elasticity measured at 70 points positioned uniformly between a position 50 nm deep and a position 1000 nm deep from each surface at 20 arbitrarily chosen points on the surface 13A of the release agent layer 13.

The release force of the release sheet 10 being peeled away from the pressure-sensitive adhesive sheet 23 can be appropriately established by determining the average modulus of elasticity at 23° C. within the above-mentioned range. Furthermore, blocking hardly occurs when the release sheet 10 or the pressure-sensitive adhesive article 20 is wound into a roll-like shape, by determining the average modulus of elasticity at 23° C. to be greater than or equal to 0.1 GPa.

Numerous concavities and convexities (roughness) are formed on the surface 13A of the release agent layer 13 so that the surface roughness Ra₁ is 100 to 700 nm. While the release force when the release sheet 10 is peeled off can be established at the appropriate value, the occurrence of blocking can be prevented by determining the surface roughness Ra₁ to be within the above range. A roller etc., with a fine roughness that has been formed on its surface by embossing for example, is impressed on the melted release agent layer 13 to produce the roughness on the surface 13A.

The surface roughness Ra₁ is the arithmetic average measured at 23° C. under the conditions of 50-fold magnification of the objective lens and of 1-fold magnification of the inner lens by an optical interferometric surface roughness meter (brand name: WYKO NT1100, manufactured by Veeco Instruments), based on ANSI/ASME B46.1:1995. If the surface roughness Ra₁ is measured by contact method, there is a risk that the measurement error will be large due to a change in the surface caused by contact because the release agent layer 13 is soft; however, if it is measured by a non-contact method as in the present embodiment, a surface roughness Ra₁ can be obtained with greater accuracy.

It is preferable that the change in the surface roughness is small even after the release sheet 10 has been left under high temperature conditions for a long period of time. For example, provided that the surface roughness of the release sheet 10 is “Ra₂” when the release sheet 10 is paid out into sheet form again after having been left in the wound and roll-like shape under a predetermined temperature condition (40° C.) for a long term (30 days), the ratio of the surface roughness (Ra₂/Ra₁) is preferably 0.9 to 1.1. Furthermore, the surface roughness Ra₂ is measured under the same conditions as those for the surface roughness Ra₁.

The release sheet 10 in the present embodiment is used in an application requiring a relatively low release force, and the release force when the release sheet 10 is peeled away from the pressure-sensitive adhesive sheet 23 is preferably 50 mN/20 mm to 500 mN/20 mm. If the release force is over the above upper limit, the release force becomes so heavy that it can cause a release problem in which a part of the pressure-sensitive adhesive is peeled off together with the release sheet 10. In addition, if the release force is below the above lower limit, the release force can be so light that the pressure-sensitive adhesive sheet 23 may abruptly slip off of the release sheet 10. Further, in this specification, the release force is a value obtained by measurement in accordance with JIS Z0237.

The undercoat layer 12 is a layer that is formed on one surface of the release sheet base 11 by extruding lamination, coating, or other, and is formed as a layer between the release sheet base 11 and the release agent layer 13. The undercoat layer 12 may be formed of a polyolefin resin composition similar to that in the above release agent layer 13, but low density polyethylene is preferably utilized so that an average modulus of elasticity as defined above thereof is preferably higher than that of the release agent layer 13. Moreover, one or more additional layer(s) may be provided on the undercoat layer 12.

The release agent layer 13 is laminated on the above undercoat layer 12 directly or through one or more other layer(s) for example by extrusion lamination of the polyolefin resin composition. For the release sheet base 11 and the pressure-sensitive adhesive sheet base 21, any bases recognized as conventional bases for the release sheet 10 or for the pressure-sensitive sheet 23 can be appropriately selected and used; for example, a resin film formed of thermoplastic resin etc., a paper, a metallic foil, or a complex of these can be utilized. As the pressure-sensitive adhesive for forming the pressure-sensitive adhesive layer 22, a non-silicone pressure-sensitive adhesive can be used without particular limitation; for example an acrylic pressure-sensitive adhesive or other is used.

In the present embodiment, while the occurrence of blocking in a roll-like shape is prevented, the release force of the release sheet 10 is good, due to determining the average modulus of elasticity and the surface roughness Ra₁ of the release agent layer 13 and the above-mentioned resin's density within the predetermined range. In addition, due to the release agent layer 13 containing the resin polymerized with a multi-site catalyst, the molecular weight and the composition of the release agent are inhomogeneous, and thus a change in its physical properties is prevented when the release agent layer 13 is heated. Accordingly, after it is transformed into a roll-like shape, even when the release sheet is stored under relatively high ambient temperature conditions for a long period, changes in the surface roughness and in the release force decrease, and thereby a good release property is maintained while blocking is prevented.

Furthermore, in the present embodiment, the release sheet and the pressure-sensitive adhesive article 20 contain substantially no silicone compound, since the release agent layer is formed of a polyolefin resin composition, and the pressure-sensitive adhesive layer 22 is formed of the non-silicone resin as well.

### EXAMPLE

Next, the present invention will be explained in further detail with reference to the examples below, but the present invention is not restricted by constitutions of the examples below.

### Example 1

Low density polyethylene (brand name: Novatec LD LC605Y, manufactured by Japan Polyethylene Corp.) having a density of 0.918 g/cm³ was extruded and coated onto a general-purpose PET film (brand name: Lumirror S-28, manufactured by Toray Industries Inc.) having a thickness of 38 μm so that an undercoat layer with thickness of 15 μm was formed. Next, polyolefin resin composition, which was obtained by mixing 70 parts by weight of ethylene-1-butene copolymer (brand name: Excellen EUL731, manufactured by Sumitomo Chemical Co., Ltd; Mw/Mn=3.9) having a density of 0.895 g/cm³ and polymerized with a multi-site catalyst, and 30 parts by weight of low density polyethylene (brand name: Novatec LD LC604, manufactured by Japan Polyethylene Corp.; Mw/Mn=8.0) having a density of 0.918 g/cm³, was extruded and coated at a temperature of 280° C. onto the undercoat layer so that a release agent layer with thickness of 20 μm was formed. Then, the release agent layer was impressed against a cooling laminate roller (lami-roller) with an embossed surface, so that a fine roughness was formed on the surface of the release agent layer while the release agent layer was cooled, and thus the release sheet of Example 1 was obtained. Further, the MFR of the above polyolefin resin composition was 8.2 g per 10 minutes.

### Example 2

It was demonstrated similar to Example 1, except that a mixture resin, which was obtained by mixing 70 parts by weight of ethylene-1-butene copolymer (brand name: Excellen VL200, manufactured by Sumitomo Chemical Co.; Ltd Mw/Mn=3.9) having a density of 0.900 g/cm³ and polymerized with a multi-site catalyst and 30 parts by weight of low density polyethylene (brand name: Novatec LD LC604; Mw/Mn=8.0), was used as the polyolefin resin composition for forming the release agent layer. Further, the MFR of the polyolefin resin composition was 3.0 g per 10 minutes.

### Comparison Example 1

It was demonstrated similar to Example 1, except that a mixture resin, which was obtained by mixing 50 parts by weight of ethylene-propylene copolymer (brand name: Tafmer P0280G, manufactured by Mitsui Chemical Inc.; Mw/Mn=2.0) having a density of 0.870 g/cm³ and polymerized with a single-site catalyst and 50 parts by weight of low density polyethylene (brand name: Novatec LD LC800, manufactured by Japan Polyethylene Corp.) having a density of 0.916 g/cm³, was used as the polyolefin resin composition for forming the release agent layer. Further, the MFR of the polyolefin resin composition was 5.9 g per 10 minutes.

### Comparison Example 2

It was demonstrated similar to as Example 1, except that low density polyethylene (brand name: Novatec LD LC605Y, manufactured by Japan Polyethylene Corp.) having a density of 0.919 g/cm³ was used as the polyolefin resin composition for forming the release agent layer. Further, the MFR of the polyolefin resin composition was 7.4 g per 10 minutes.

[Evaluation of Physical Properties]

A surface roughness Ra₁ and an average modulus of elasticity at 23° C. for the release agent layer in the release sheet for each Example and Comparison Example were measured by the above-mentioned measurement methods.

Furthermore, acrylic pressure-sensitive adhesive (brand name: PL shin, manufactured by Lintec Corp.) was coated onto a PET film having a thickness of 50 μm with a test coater so that a thickness thereof was made to be 23 μm, and then was dried at 120° C. for 1 minute so that a pressure-sensitive adhesive layer was formed so as to obtain a pressure-sensitive adhesive sheet. The release sheet of each Example and Comparison Example was bonded to the pressure-sensitive adhesive sheet such that the release agent layer made contact with the pressure-sensitive adhesive layer, thereby a pressure-sensitive adhesive article was produced, and then the release force of the release sheet in the pressure-sensitive adhesive article was measured. The measured value of each of the physical properties is shown in FIGS. 1 and 2.

[Evaluation of Physical Properties after Heat Acceleration]

A release sheet having a width of 340 mm and a length of 1000 mm was wound around a core having a diameter of 92 mm so as to produce a roll-like shaped release sheet. The roll-like shaped release sheet was treated with the heat acceleration by leaving it in a thermostatic chamber at 40° C. for 30 days. After the release sheet that had been treated with the heat acceleration was paid out from the roll into a sheet-like shape, the surface roughness Ra₂ after heat acceleration was measured. Furthermore, the release sheet after heat acceleration was paid out from the roll, and then a pressure-sensitive adhesive sheet was bonded to the sheet-like release sheet that had been paid out so as to produce a pressure-sensitive adhesive article in a manner similar to that which is described in the above-mentioned evaluation of physical properties. Then, the release force of the release sheet after heat acceleration in the pressure-sensitive adhesive article was measured. The surface roughness Ra₂ and the release force after heat acceleration, the surface roughness ratio Ra₂/Ra₁, and the change ratio of release force calculated by the formula below are shown in Tables 1 and 2.

Change Ratio of Release Force=|(Release Force before Heat Acceleration−Release Force after Heat Acceleration)/Release Force before Heat Acceleration|×100(%)

[Evaluation of Anti-Blocking Property]

The anti-blocking property was evaluated by paying out the release sheet from the roll which had been treated with the heat acceleration. The case where the release sheet could be paid out smoothly due to little blocking was reported as “0” in Table 1. On the other hand, the case where it was difficult to pay out the release sheet due to substantial blocking was reported as “x”.

TABLE 1

| | Surface | | Surface | | Average |
|---|---|---|---|---|---|
| | Roughness | | Roughness | Anti- | Modulus of |
| | [nm] | | Ratio | Blocking | Elasticity |
| | Ra₁ | Ra₂ | Ra₂/Ra₁ | Property | [GPa] |
| Ex. 1 | 618 | 607 | 0.982 | ∘ | 0.26 |
| Ex. 2 | 422 | 410 | 0.972 | ∘ | 0.23 |
| Comp. Ex. 1 | 450 | 336 | 0.747 | x | 0.15 |
| Comp. Ex. 2 | 512 | 514 | 1.004 | ∘ | 0.36 |

TABLE 2

| | | | Change |
|---|---|---|---|
| | Release Force [mN/20 mm] | | Ratio of |
| | Before Heat | After Heat | Release Force |
| | Acceleration | Acceleration | [%] |
| Ex. 1 | 126 | 124 | 1.6 |
| Ex. 2 | 251 | 248 | 1.2 |
| Comp. Ex. 1 | 70 | 59 | 15.7 |
| Comp. Ex. 2 | 3380 | 3385 | 0.15 |

As shown in Tables 1 and 2, in Examples 1 and 2 the appropriate value of the release force could be determined, by determining the surface roughness Ra₁ to be 100 to 700 nm and the average modulus of elasticity at 23° C. to be 0.1 to 0.3 GPa, and by using the resin polymerized with the predetermined multi-site catalyst. Furthermore, since the change in physical properties, such as the surface roughness and so on, could be mitigated even when heat acceleration was carried out, the good anti-blocking property and release force could be maintained.

In contrast, in Comparison Example 1, the surface roughness Ra₁ and the average modulus of elasticity at 23° C. could be determined for the appropriate value; however, because the composition did not contain a resin with density of 0.800 to 0.905 g/cm³ that was polymerized with multi-site catalyst, blocking occurred when heat acceleration was carried out, due to a change in physical properties such as the surface roughness and so on. Furthermore, it is understood that the excellent release property was not maintained during long-term storage, as evidenced by the fact that the release force decreased after heat acceleration. On the other hand, in Comparison Example 2, although the anti-blocking property could be made good by determining the average modulus of elasticity at 23° C. to be high, the release sheet having the excellent release property could not be obtained due to the excessively high release force.

1. A release sheet comprising:
a release agent layer that is formed of a polyolefin resin composition containing a polyolefin thermoplastic resin having a density of 0.800 to 0.905 g/cm³ and polymerized with a multi-site catalyst, an average modulus of elasticity of the release agent layer at 23° C. in 50 to 1000 nm depths from a surface thereof measured by Nano Indentation Method being 0.1 to 0.3 GPa, a roughness formed on the surface so that the surface roughness Ra₁ is 100 to 700 nm.

2. The release sheet as claimed in claim 1, wherein the surface roughness ratio Ra₂/Ra₁ is 0.9 to 1.1.
(Provided “Ra₂” is a surface roughness of said release agent layer after the release sheet has been left for 30 days in 40° C. ambient conditions.)

3. The release sheet as claimed in claim 1, wherein a melt flow rate of said polyolefin resin composition is 1 to 20 g per 10 minutes.

4. The release sheet as claimed in claim 1, wherein said polyolefin thermoplastic resin contains at least one polyolefin resin selected from the group consisting of polyethylene, polypropylene, polybutene, poly(4-methyl-1-pentene), and a copolymer of ethylene and α-olefin with a carbon number of 3 to 10.

5. The release sheet as claimed in claim 1, wherein said release agent layer is laminated on a base through an undercoat layer.

6. The release sheet as claimed in claim 1, containing substantially no silicone compound.

7. A pressure-sensitive adhesive article comprising:
a base;
a release agent layer that is laminated on said base; and
a pressure-sensitive adhesive layer that is laminated on and in contact with said release agent layer,
said release agent layer formed of a polyolefin resin composition containing a polyolefin thermoplastic resin having a density of 0.800 to 0.905 g/cm³ and polymerized with a multi-site catalyst, an average modulus of elasticity of the release agent layer at 23° C. in 50 to 1000 nm depths from a surface thereof measured by Nano Indentation Method being 0.1 to 0.3 GPa, a roughness formed on the surface so that the surface roughness Ra₁ thereof is 100 to 700 nm.

8. The pressure-sensitive adhesive article as claimed in claim 7, wherein said pressure-sensitive adhesive layer is formed of an acrylic pressure-sensitive adhesive.
